(19) United States
(12) Patent Application Publication
(10) Pub. No.: US 2002/0032648 A1
(43) Pub. Date: Mar. 14, 2002

(54) Method for installing credit card processing for internet merchants

(76) Inventors: Marmon Pine, Des Plaines, IL (US); Donald S. Pine, Glendale, AZ (US)

Correspondence Address: Jeffrey A. Pine, BANIAK PINE & GANNON, Suite 1200, 150 N. Wacker Drive, Chicago, IL, 60606, US

(21) Appl. No.: 09/835,105

(22) Filed: Apr. 13, 2001

Related U.S. Application Data
(60) Provisional application No. 60/197,428, filed on Apr. 14, 2000.

(51) Int. Cl. G06F 17/60

(52) U.S. Cl. 705/39; 705/35; 705/26

(57) ABSTRACT

A method is disclosed for enrolling an Internet merchant thereby permitting credit card processing for the transaction of goods and/or services for that Internet or electronic merchant. In order to efficiently and effectively enroll the Internet merchant in a timely manner, the electronic merchant empowers a responsible, named party through a limited power of attorney, thereby allowing the party to enroll the merchant without the delays inherent in the current enrollment procedures for Internet credit card processing.

A portion of the disclosure of this patent document contains material that is subject to copyright protection. The copyright owner has no objection to the facsimile reproduction by anyone of the patent document or the patent disclosure, as it appears in the in the Patent and Trade Office files and rrecords, but otherwise reserves all copyright rights whatsoever.

### TECHNICAL FIELD

The present invention relates to a method for enrolling an electronic merchant such that he can accept credit cards for the payment of goods and/or services sold on the Internet. More specifically, the present invention relates to a method whereby a sales agent enrolls an Internet merchant, obtains a limited power of attorney from that merchant enabling a responsible named party to act on behalf of the electronic merchant and contract for all of the services and software to allow the merchant the ability to accept and process credit cards for the purchases of the merchant's goods and/or services via the Internet.

### BACKGROUND OF THE INVENTION

There are many ways in which customers can pay for the goods and/or services that they desire, for example, cash, check or credit cards. In this specification, except where expressly stated below, the transactions described herein refer to credit card transactions.

For reasons related to actuarial statistics related to fraud, standard merchants (entities wishing to sell goods and/or services) have historically been divided into essentially three categories by credit card processing financial institutions: retail store merchants, mail order merchants and telephone order merchants.

With retail store merchant transactions, the customers, the credit cards and the customers' signatures are all present at the transaction site. In mail order merchant transactions, only the customers' signature (and credit card information) is present at the transaction; the merchant does not see the customers or their credit cards. Finally, with telephone order merchant transactions, the merchant does not see the customers, their credit cards or their signatures, all that is available to the telephone order merchant is the credit card information. In order for each of these transaction scenarios to take place, the standard merchant must accept (and be able to process) the customers credit card information.

Standard merchants who wish to accept credit cards for the purchase of goods or services in their stores must apply for a “merchant number” to the various credit card issuers (Visa, MasterCharge, American Express, Discover, etc.). The credit card issuers have established intermediary companies to process the applications and also process the credit card transactions. These intermediaries may be a bank or a financial institution (underwriters and transaction processors), or else they may be privately owned Independent Service Organizations (ISO). The line between the function of the banks and the ISOs has blurred as banks are beginning to act as ISOs, and ISOs are beginning to act as banks.

An ISO, in turn, establishes a marketing organization consisting of a large number of independent or self employed sales agents to contact the merchants, and enroll the merchants in the service. The agents also install everything required to process credit card transactions. Agents are paid only after the installation, when the merchant is able to process credit card transactions. The agent is not paid until the installation is complete.

In general, in order to accomplish the foregoing, first the agent must locate a prospect merchant. The agent visits the merchant and enrolls him in the program. The agent then collects the necessary application information and required documents to complete the enrollment process. If the merchant is going to lease the equipment required to process credit card transactions, then the merchant must accept the terms of the lease, otherwise the merchant elects to pay cash for the required equipment.

The agent then submits the enrollment data to the ISO, who must approve of the application and submit the information to the underwriting or processing bank. The underwriting bank will, if everything is acceptable, approve the credit and issue a merchant number for that merchant. The ISO forwards the merchant number to the agent, who then installs and demonstrates the credit card processing equipment to the merchant. The merchant then signs off on the installation (or verifies with the leasing bank if an equipment lease is involved), and the agent can get paid. Over the years, very effective techniques have evolved for implementing the above-listed steps to enroll standard merchants.

Advances in technology have recently created a fourth merchant category, the Internet merchant (also known as the electronic merchant or e-merchant). The Internet merchant sells goods and/or services electronically by using the Internet. The Internet merchant lists his goods and/or services on a Website and potential purchasers can view these goods and/or services from their computer or similar device. When the potential purchaser decides to purchase goods or services, they usually provide their credit card information and the transaction can occur. Of course, the credit card transaction can only occur if the electronic merchant has been enabled to accept and process credit cards by a transaction processor, and possesses a merchant number issued for that purpose.

There are certain problems inherent with enabling an electronic merchant to accept and process credit cards. The electronic merchant must perform certain steps, i.e., setting up a website, etc., for which the electronic merchant usually has no knowledge and is not accustomed. In most cases, these steps require a certain knowledge and, because the electronic merchant does not have this knowledge, the entire process ends up either slowing down or does not occur.

It would be a great advantage if a method was utilized in which the steps that the electronic merchant has very little experience with were performed by another party that had the authority to perform those steps.

### SUMMARY OF THE INVENTION

The present invention facilitates the steps necessary in order to provide an electronic merchant with the ability to accept and process credit card information obtained over a global communications network such as the World Wide Web or the Internet. The present invention greatly increases the chance that the necessary steps will occur by taking the responsibility of certain steps away from the electronic merchant and giving the responsibility for those steps to others.

There are a number of steps that must occur before an electronic merchant can accept credit card transactions for the sale of goods or services over the Internet. A number of these steps are steps that the electronic merchant rarely performs and thus is not comfortable performing. Most of these steps need to be performed by the electronic merchant due to the private nature, i.e., providing personal information, obtaining passwords, etc. The present invention allows the electronic merchant to execute a limited power of attorney, thereby allowing another party, the responsible party, to perform the necessary steps that will allow the electronic merchant the ability to accept credit cards.

Once the limited power of attorney is executed, the responsible party can perform certain tasks for which it has a specific knowledge. These steps include registering a domain name, establishing an account with an Internet Service Provider, establishing an account with a host, establishing a website, setting up an account with the transaction processor, modifying the website to accept credit card information from customers, etc. If not for the responsible party, these steps would have to be performed by the electronic merchant, and would not happen as fast, or not happen at all.

By allowing the responsible party the limited power to perform these steps, the process of enabling an electronic merchant to accept credit cards over the Internet occurs at a much faster rate.

Other features and advantages of the present invention will be apparent to those having ordinary skill in the art based on the accompanying drawings and description.

### BRIEF DESCRIPTION OF THE DRAWINGS

FIG. 1 is a flow chart of the prior art method for enabling an electronic merchant to accept credit cards;

FIG. 2 is a table comparing the prior art procedural steps and the procedural steps in accordance with the present invention, enabling a merchant to accept credit card;

FIG. 3 is a flow chart of the method for enabling an electronic merchant to accept credit cards in accordance with the present invention.

### DETAILED DESCRIPTION OF THE INVENTION

In general, in order for a standard merchant to be able to accept credit cards, first the agent must locate a prospect merchant. The agent visits the merchant and enrolls him in the program. The agent then collects the necessary application information and required documents to complete the enrollment process. If the merchant is going to lease the equipment, then the merchant must accept the terms of the lease; otherwise the merchant elects to pay cash.

The agent then submits the enrollment data to the ISO, which must approve of the application and submit the information to the underwriting or processing bank. The underwriting bank will, if everything is acceptable, approve the credit and issue a merchant number for that merchant. The ISO forwards the merchant number to the agent, who then installs and demonstrates the credit card processing equipment to the merchant. The merchant then signs off on the equipment or verifies with the leasing bank if an equipment lease is involved, and the agent can get paid. Over the years, very effective techniques have evolved for implementing the above-listed steps to enroll standard merchants.

Advances in technology have recently created a fourth merchant category, the Internet merchant (also known as the electronic merchant or e-merchant). The Internet merchant sells goods and/or services electronically by using the Internet. The Internet merchant lists his goods and/or services on a Website and potential purchasers can view these goods and/or services from their computer or similar device. When the potential purchaser decides to purchase goods or services, they usually provide their credit card information and the transaction can occur. Of course, the credit card transaction can only occur if the electronic merchant has been enabled to accept and process credit cards by a transaction processor, and possesses a merchant number issued for that purpose.

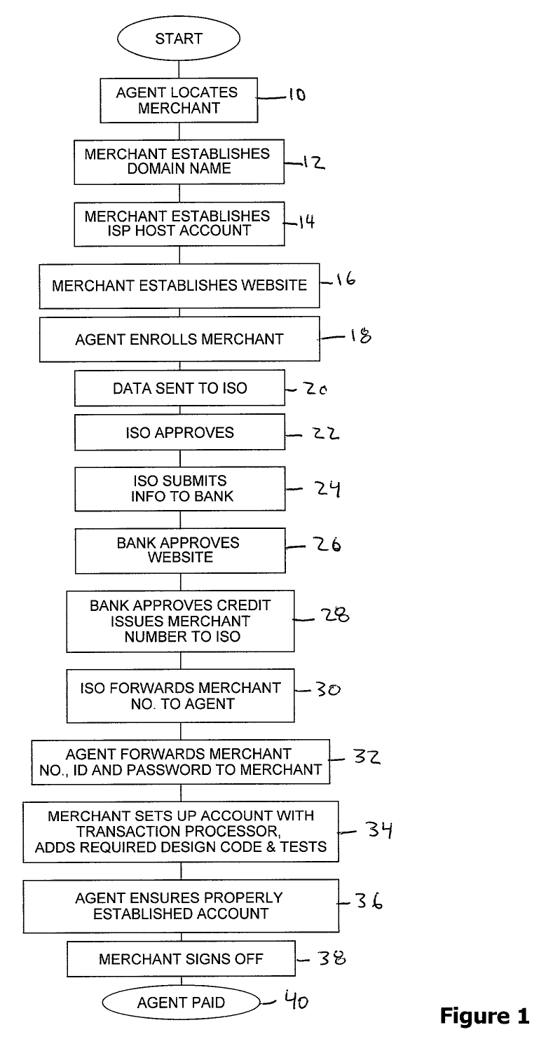

In order for an electronic merchant to be able to accept credit card transactions over the Internet, i.e., to accept credit cards, certain steps must occur. FIG. 1 shows a flow chart of the necessary steps that enable an electronic merchant to make credit card transactions.

First, an agent must locate a prospective merchant (or vice-versa) 10. At that time, if it has not already occurred, the merchant must establish a domain name 12 and an Internet Service Provider or ISP host account 14. The merchant must also establish a website 16 that customers can visit and purchase goods or services. The merchant may already have a website.

Although not always necessary, the agent visits the electronic merchant. In some situations the entire enrollment could be done over the phone or by using the Internet. The agent then enrolls the electronic merchant in the program 18. The agent then collects the necessary application information and required documents to complete the enrollment process. The merchant must accept the terms of the lease for required credit card processing software, components and services, or elect to pay cash.

The agent then submits the enrollment data to the ISO 20, who must approve of the application 22 and submit the information to the underwriting or processing bank 24. The underwriting bank will, if everything is acceptable, approve the website 26 and approve the credit and issues a merchant number for that merchant 28. In some situations the line between the ISO and the underwriting bank is starting to blur. In certain situations the ISO acts as a bank. In other situations the bank acts like an ISO. Either way some of the foregoing steps may be combined (or may become unnecessary altogether).

The ISO then forwards the merchant number to the agent 30, who forwards the merchant number, identification information and password to the electronic merchant 32. The merchant then sets up an account with the transaction processor, and modifies the website accordingly 34. The website is modified by adding design code that will enable a customer to enter credit card information, etc. The agent then demonstrates the credit card processing procedure to the electronic merchant 36. The electronic merchant then signs off on the website (or verifies with leasing bank if a lease is involved) 38 and the agent can get paid 40.

The steps are as follows:

1. an agent locates a prospective merchant 10;

2. if not previously established, the merchant registers a domain name 12, establishes an account with an Internet Service Provider or ISP, such as America Online, etc., in order to be able to receive electronic mail and have access to the Internet 12;

3. the merchant establishes an account with an Internet Website hosting company or a host 14;

4. the merchant establishes a suitable Website on the Internet 16;

5. the agent enrolls the merchant, i.e., collects the application information and required documents (the merchant must accept the terms of the lease for required credit card processing services, or elect to pay cash) 18;

6. the agent submits the enrollment data to the ISO 20;

7. if acceptable, the ISO approves the application 22 and submits the information to the underwriting or processing bank 24;

8. the underwriting bank reviews and approves the merchant's Website (usually by reviewing the Website on the Internet) 26;

9. the underwriter bank approves credit and issues a merchant number to the ISO 28;

10. the ISO forwards the merchant number to the agent 30;

11. the agent informs the merchant of the approval, and passes on the merchant number, ID and password for the transaction processors account to the merchant 32;

12. the merchant sets up an account with the transaction processor, adds the required design code required to process credit card sales to the merchant's Website, and tests a transaction 34;

13. the agent ensures that the merchant has properly established a transaction account 36;

14. the merchant signs off on the process (or verifies with leasing bank if a lease is involved) 38;

15. the agent gets paid 40.

Generally, each of the steps listed above needs to be performed in order for a merchant to be able to accept credit cards on the Internet. However, as described previously, many of these functions can be performed by different entities and some of the steps may be combined. For example, if the ISO is acting as a bank, steps 7 through 10 (24, 26, 28 and 30) may all be performed by the ISO. It should be appreciated that there are other steps or different order of the above-listed steps that may be used to effect the same results.

These installation steps are quite technical, and for purposes of the activities described above, the steps are presently beyond the scope of the ISOs or their agents. Additionally, these steps require the technical intervention of the electronic merchant, an event completely outside of the agent's control.

In reality, the electronic merchant hires a programmer to perform steps 2, 3, 4, and 12 (12, 14, 16 and 34) above, otherwise it is unlikely that the underwriting bank will grant a merchant number.

In practice, if the agent does enroll an electronic merchant 18, it may take weeks or months to complete the above steps, and therefore weeks or months for the agent to get paid (compared to days for standard merchants). Frequently, the merchant loses interest, or the Website design isn't completed, resulting in lost sales and time for the particular agent. As a result, although the volume of potential electronic merchants is growing rapidly, few orders are being processed by ISOs or agents for electronic merchants.

Another way that the Internet merchant can be enrolled to accept credit cards does not involve a sales agent at all. Instead, advances in technology have allowed selling organizations to bypass the agent (i.e., bypass personal visits to the prospective electronic merchant), instead using the Internet to accomplish this enrollment. The transactions and communications that the agent would perform in person are replaced by transactions and communications via the Internet. The steps pertaining to this second electronic merchant enrollment procedure are as follows:

a. a prospective merchant electronically (or otherwise) communicates with the selling organization, usually through the selling organizations Website;

b. if not previously established, the merchant registers a domain name, establishes an account with an Internet Service Provider (ISP), such as America Online, in order to receive electronic mail and access to the Internet;

c. the merchant establishes an account with an Internet Website hosting company or a host;

d. the merchant establishes a suitable Website on the Internet;

e. the merchant provides information and required documents to the ISO;

f. if acceptable, the ISO approves the application and submits the information to the underwriting or processing bank;

g. the underwriting bank reviews and approves the merchant's Website (usually by reviewing the merchant's Website on the Internet);

h. the underwriter bank approves credit and issues a merchant number to the ISO;

i. the ISO forwards the merchant number, ID and password for the transaction processors account to the merchant;

j. the merchant or contracted programmer sets up an account with the transaction processor, adds the required design code required to process credit card sales to the merchant's Website, and tests a transaction;

k. the merchant signs off on the process.

Again, these installation steps may be modified as described above, are quite technical, and for purposes of the activities described above, the steps are presently beyond the scope of the ISOs or the merchants. In reality, the merchant hires a programmer to perform steps b, c, d, and j above otherwise it is unlikely that the merchant will receive a merchant number. As such the merchant is at the mercy of the programmer and his schedule. In many instances, this is the stage that holds up the entire process to the point that few orders are being processed for electronic merchants.

In order to more effectively and more efficiently perform the above-listed steps, the present invention assigns the responsibility for steps 2, 3, 4 and 12, or b, c, d and j described above through a limited power of attorney to a named, responsible party (party).

This party takes on the merchant's responsibility (and liability) for certain procedures in order for the merchant to be able to obtain a merchant number as quickly as possible.

In the preferred embodiment of the present invention, an application form to be used to sign up the electronic merchant would have the following format:

APPLICATION FORM

| Domain Name requested:______________ | |
|---|---|
| Five alternatives: | 1.______________ |
| | 2.______________ |
| | 3.______________ |
| | 4.______________ |
| | 5.______________ |

If this is a transfer instead of a new registration:
What is the exact Domain Name to be transferred?_____
Where is it Parked or Hosted? (Verio, Mindspring, etc.)____
If transfer (or existing Site): USER ID___________

PASSWORD (case sensitive)___

NOTE: If Transferring Name or Web Site, Authorization Letter on company
letterhead must accompany application. If available, please include a copy of
email establishing account or account setup page.
SUBSCRIBER INFORMATION (Please Print)
First Name:_____M.I.:__Last Name:_____
Company Name:__________
Address (line 1):__________
Address (line 2):__________
City:______State:____Zip:___
Phone:____Fax:____E-mail:_____

PAYMENT PROCESSOR INFORMATION (Please Print)

Owner's Social Security #:_____# employees:_____
Credit Card (Used only for AuthorizeNet backup) Type__#__Exp(MMYY)__
% business by Internet:__Windows 3.1__95__98__2000__NT__
How do you connect to Internet? Dial up modem__Cable Modem__DSL__
Other____
How computer savvy are you? Beginner__Intermediate__Advanced__
Type of Business:____________________
In State Tax Rate:____What time zone are you in?____
Shipping and Handling Charges: None over $__Flat Rate__Straight %__
Refund Policy: Alt sales final___Return within___days

Copyright 2000 Agents Pick, Inc.

Of course, other formats may be utilized to obtain similar information

necessary to proceed. In the preferred embodiment of the present invention, a
limited power of attorney form, which is to be used to sign up the electronic
merchant would have the following format:

POWER OF ATTORNEY

____________________,the authorized party of Merchant
____________________,(“PRINCIPAL”), herewith Company
Name appoints Agents Pick, Inc. of Des Plaines, Illinois, as their attorney in fact,
to act in the place and stead and with the same authority as PRINCIPAL would
have to do the following acts:

To act for me in the regard to the following:

1. DOMAIN NAME a). Execute any and all agreements necessary to select and register an Internet Web site “Domain Name”, such registration to be valid for a period of one year, cost to PRINCIPAL not to exceed $35; or, b). in the event that PRINCIPAL already has a current, registered “Domain Name”, use such current Domain Name in a manner determined by Agents Pick, Inc. as necessary to establish an Internet Web Site, such use including the transfer of Domain Name to a Web Hosting company selected in 2, below.

2. HOSTING COMPANY a). Execute any and all agreements necessary to open an account with a Web Hosting company to host the PRINCIPAL's website for a minimum period of three (3) months, costs of such account, to PRINCIPAL, not to exceed $50 (non-refundable) for setup of such account, and $75 (refundable if canceled, in writing, within 30 days of date of this document) for the total three months costs; or, b). in the event that PRINCIPAL already has such an account, use such account in a manner determined by Agents Pick, Inc. as necessary to establish the Internet Website described in 3., below.

3. WEBSITE a). Execute any and all agreements required to design and install a Web Site at the Web Hosting company chosen in step 2, above; or b). Modify PRINCIPAL's existing Web Site for E-commerce, cost to PRINCIPAL for either 3.a). or 3.b). not to exceed $100 (non-refundable) for setup of Web Site (unless modified specifically in writing and attached herein).

Again, there are many different formats that may be utilized to achieve the same goal; to transfer the responsibility of certain steps from the electronic merchant, who may not be able to easily or quickly accomplish those steps, to a party that can. The present invention is not to be limited to the format disclosed herein, and instead is meant to embody the many different ways that the information (Application Form), and authority (Limited Power Of Attorney) can be transferred between the participants.

The limited power of attorney acts to memorialize any and all agreements between the merchant and the responsible party, and defines the authority specifically bestowed on the responsible party. Both the merchant and the responsible party are thus protected from liability in certain situations. The merchant has granted specific instructions to the responsible party, and that party has no right to act on behalf of the merchant outside of those instructions. The party, not the merchant, would then be responsible for those non-specified acts. On the other hand, the responsible party cannot be held liable to the merchant when it acts reasonably in accordance with the merchant's grant of authority.

The present invention provides uniformity in approach and coordination of all the involved parties, while reducing the time between taking the application, enacting the necessary agreements, and enabling the Internet merchant to accept and process credit card transactions, otherwise known as going live.

In fact, the entire process, from the initial meeting with the merchant (or contact with the merchant via the Internet), until going live, can be as quick as two hours. Previously, the same process would take days, weeks and sometimes months. Additionally, using the present invention assures the proper interface between a transaction processor, such as AuthorizeNet, CyberCash, etc. and the electronic merchant.

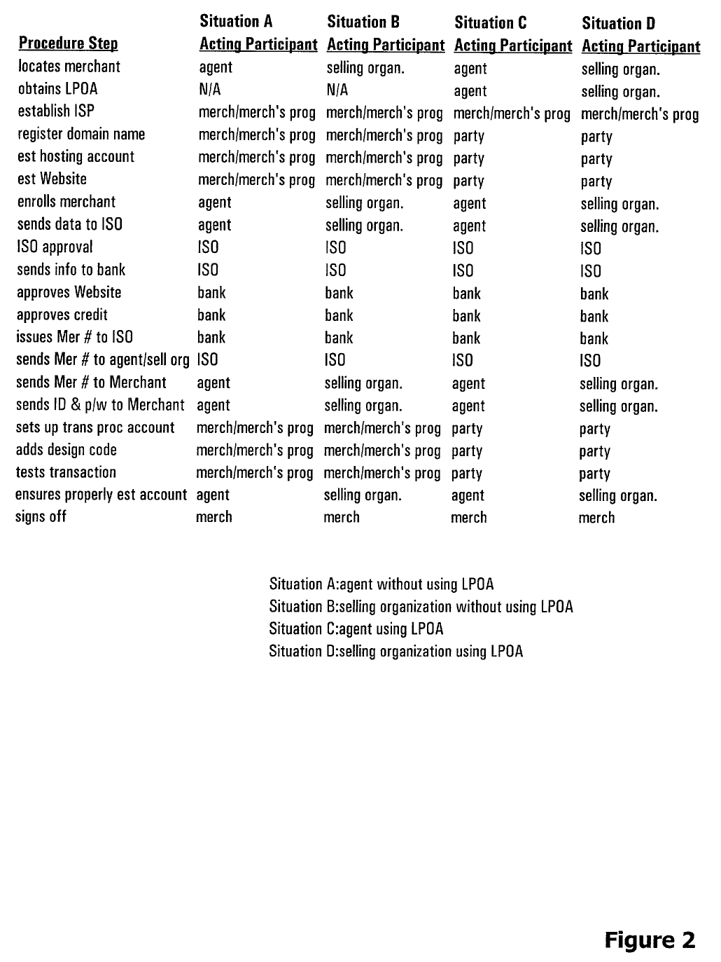

As shown in FIG. 2, situations A and B list the acting participants for each step when there is no executed limited power of attorney (LPOA). Situations C and D utilize the limited power of attorney and thus certain procedures that previously would have been performed by the electronic merchant or the electronic merchant's programmer (and thus delayed), are now under the control of the responsible, named party or the party.

It can be seen that certain steps are now under the control of the responsible party, no longer under the control of the merchant or merchant's programmer (or web developer). In particular, the following steps are now accomplished by the responsible party, or accomplished by a subcontractor that the responsible party works with (usually on a continuous basis):

register domain name

establish hosting account

establish website

set up transaction processor account

add design code to website

perform transaction tests

Of course, as described herein there are other steps that can be transferred to the responsible party, and the responsible party can be further limited in its responsibility, i.e., not granted the authority to establish a website, etc.

This ensures that these steps which normally are the cause for the delay, i.e., registering a domain name, establishing a hosting account, establishing a website, etc., will be accomplished in an efficient and timely manner.

The present invention ensures that an Internet or electronic merchant can be completely and properly enrolled and installed by an agent (or a selling organization) in a reduced timeframe. When the method of the present invention is employed, the time required to enroll and install the electronic merchant is similar to that required for the standard merchant and the likelihood of a completed installation is as high as the likelihood of a completed installation for a standard merchant.

The unique and novel element of the inventive method is the introduction of a limited power of attorney, in which the merchant empowers the party to act on the merchant's behalf for a number of the above-described steps. The limited power of attorney is an authorization by the merchant, which names and empowers the party to enter into all of the agreements necessary to complete at least steps 2, 3, 4, and 12, (12, 14, 16 and 34) or b, c, d, and j listed above. In some situations, for example where a merchant has already completed certain steps, the limited power of attorney may be further limited in the authority that it grants.

Otherwise, the limited power of attorney vests total control to a party of steps 2, 3, 4 and 12 (12, 14, 16 and 34), or b, c, d and j, which in the absence of this invention are left to the merchant and a myriad of unknown subcontractors. Through the limited power of attorney, the process described in these steps can be quickly completed, and the party retains control of the transaction from the execution of the limited power of attorney until going live. The use of the present invention assures the selling agent of the timely execution of these steps, thereby ensuring that the selling agent is timely paid for his services.

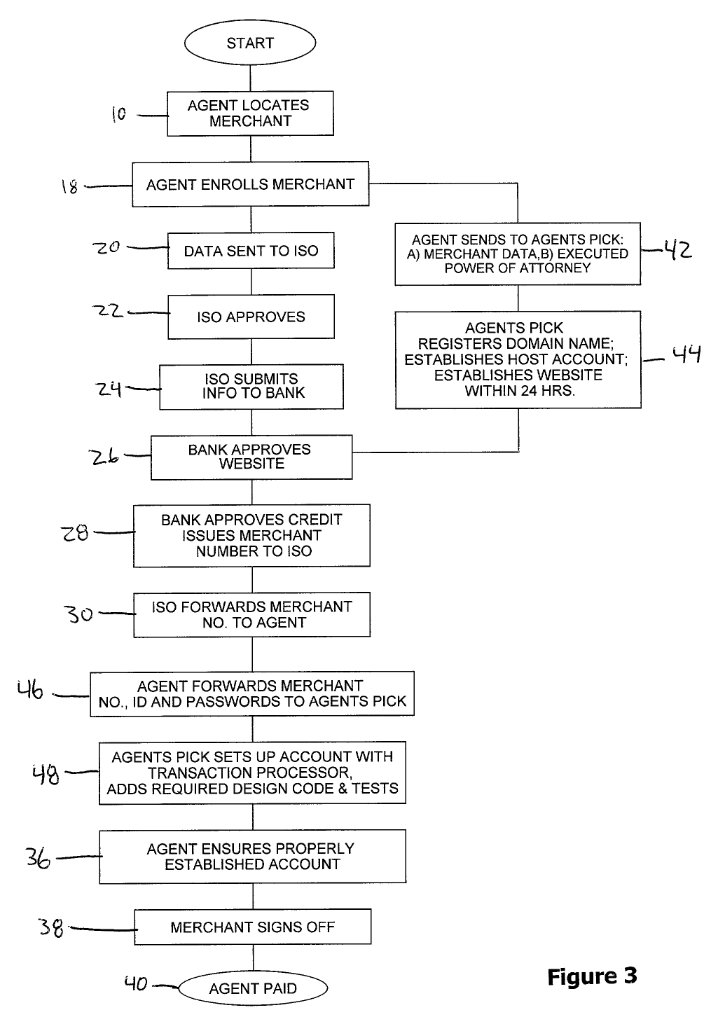

In accordance with the present invention, for an electronic merchant to be able to accept credit card transactions over the Internet, the same steps as described above must occur, however, these steps are no longer the responsibility of the electronic merchant. FIG. 3 shows a flowchart of the necessary steps in accordance with the present invention, that enable an electronic merchant to make credit card transactions.

First, an agent must locate a prospect merchant (or vice-versa) 10. Agent enrolls merchant 18. The merchant must accept the terms of the lease for required credit card processing services, or elect to pay cash.

Agent collects Merchant Data and executed power of attorney (enrollment information). In the Power merchant authorizes the responsible party (in this example, the responsible party is Agents Pick) to perform tasks as described herein. Agent sends to Agents Pick the Merchant Data and the executed Power of Attorney 42. Subsequently, and to the extent required (and described above), Agents Pick registers the Domain Name, Establishes an ISP Host account, and creates a Website 44. These steps, 42 44 can occur within hours.

Concurrent with steps 42 44, the agent sends the Merchant data to the ISO 20, who must approve of the application 22 and submit the information to the underwriting or processing bank 24. The underwriting bank will review the website created by Agents Pick 44 (or Agents Pick's authorized website developer), and the submitted Merchant data 24. If everything is acceptable, the bank approves the website 26, and approves the credit and issues a merchant number for that merchant 28. In some situations the line between the ISO and the underwriting bank is starting to blur. In certain situations the ISO acts as a bank. In other situations the bank acts like an ISO. Either way some of the foregoing steps may be combined (or may become unnecessary altogether).

The ISO then forwards the merchant number to the agent 30, who forwards the merchant number, identification information and password to Agents Pick 46. Agents Pick then sets up an account with the transaction processor, and modifies the website, and performing necessary testing 48. The website is modified by adding design code that will enable a customer to enter credit card information, etc. The agent then demonstrates the credit card processing procedure to the electronic merchant 36. The electronic merchant then signs off on the website (or verifies with the leasing bank if a lease is involved) 38 and the agent can get paid 40.

The foregoing detailed description of the invention is intended to be illustrative and not intended to limit the scope of the invention. Changes and modifications are possible with respect to the foregoing description, and it is understood that the invention may be practiced otherwise than that specifically described herein and still be within the scope of the claims.

1. A method for enabling an Internet merchant to receive a merchant number comprising the steps of:
a) executing a limited power of attorney, said limited power of attorney naming and empowering a party to act on behalf of said merchant;
b) assisting said merchant in obtaining a merchant number by utilizing said limited power of attorney.

2. The method for enabling an Internet merchant to receive a merchant number of claim 1, wherein said assisting said merchant in obtaining a merchant number comprises the step of establishing a suitable Website on the Internet.

3. The method for enabling an Internet merchant to receive a merchant number of claim 2, further comprising the steps of:
a) establishing an account with an Internet Service Provider in order to receive electronic mail and to access the Internet;
b) establishing an account with an Internet Website hosting company;
c) enrolling said merchant by collecting information and documents pertaining to said merchant and submitting said information to an ISO.

4. The method for enabling an Internet merchant to receive a merchant number of claim 3, further comprising the step of adding required design code to said merchant's Website.

5. A method for enabling an Internet merchant to receive a merchant number comprising the steps of:
a) locating a prospect merchant and obtaining a limited power of attorney;
b) establishing an account with an Internet Service Provider in order to receive electronic mail and to access the Internet;
c) establishing an account with an Internet Website hosting company;
d) establishing a suitable Website on the Internet;
e) visiting said merchant;
f) enrolling said merchant by collecting application information and documents;
g) obtaining acceptance of terms for credit card processing services;
h) submitting enrollment data to an ISO for approval of said merchant;
i) obtaining approval of said merchant;
j) obtaining approval from underwriting/processing bank;
k) obtaining a merchant number on behalf of merchant;
l) forwarding merchant number, an ID and a password for the transaction processors account to merchant.

6. The method for enabling an Internet merchant to receive a merchant number of claim 5, further comprising the steps of:
a) adding required design code to merchant's Website;
b) setting up account with transaction processor;
c) testing transaction;
d) visiting merchant and ensuring that merchant has properly established transaction account.
